(19) United States
(12) Patent Application Publication
(10) Pub. No.: US 2021/0280845 A1
(43) Pub. Date: Sep. 9, 2021

(54) Lithium-Ion Galvanic Cells

(71) Applicant: CPT Group GmbH, Hannover (DE)

(72) Inventors: Udo Kreißig, Chemnitz (DE); Andreas Lenk, Bannewitz / OT Possendorf (DE); Uwe Scharf, Remse (DE); Rene Möller, Rudolstadt (DE); Rene Böhm, Callenberg / OT Meinsdorf (DE); Jana Fuchs, Plauen (DE); Daniel Haase, Chemnitz (DE)

(73) Assignee: CPT Group GmbH, Hannover (DE)

(21) Appl. No.: 16/338,773

(22) PCT Filed: Oct. 5, 2017
(86) PCT No.: PCT/EP2017/075305

§ 371 Date: Apr. 2, 2019

(30) Foreign Application Priority Data
Oct. 11, 2016 (DE) 10 2016 219 661.8

(51) Int. Cl. H01M 4/04; H01M 10/0525; H01M 50/46; H01M 10/0583; H01M 4/139

(52) U.S. Cl. CPC H01M 4/0407; H01M 10/0525; H01M 4/0423; H01M 4/139; H01M 50/46; H01M 10/0583; H01M 4/0409

(57) ABSTRACT

Various embodiments include a method for producing a galvanic lithium-ion cell comprising: separating a first electrode material from a second electrode material using a separator; and applying the first electrode material to a first side of the separator by coating.

### CROSS-REFERENCE TO RELATED APPLICATIONS

This application is a U.S. National Stage Application of International Application No. PCT/EP2017/075305 filed Oct. 5, 2017, which designates the United States of America, and claims priority to DE Application No. 10 2016 219 661.8 filed Oct. 11, 2016, the contents of which are hereby incorporated by reference in their entirety.

### TECHNICAL FIELD

The present disclosure relates galvanic cells. Various embodiments may include methods for producing a galvanic lithium-ion cell.

### BACKGROUND

In the prior art in relation to the production of lithium-ion cells, it is known to apply an electrode material to collector foils of the cell to be produced. The collector foils are then cut to size. A separator is arranged between two respective coated collector foils. In this case, it proves to be a challenge to ensure that the separator is not broken or damaged. This is because otherwise electrons could pass directly through the damaged separator from the first electrode material to the second electrode material. Such a short circuit should be avoided.

Furthermore, at the present time, the production costs in the automotive sector, without taking into account the material costs for lithium-ion cells or lithium-ion accumulator cells, are of an order of magnitude of around 100 euro/kWh. The power density of lithium-ion accumulators, as are used for instance for batteries for electric vehicles or hybrid vehicles, is also only around 0.3 kWh/kg. This high specific weight of the accumulators and the high production costs are a considerable obstacle to a faster and more expansive implementation of electromobility. The lithium solid-state battery (SSB), which is currently still being developed, is a comparatively promising approach for reducing the specific material costs of the accumulator cell. However, it is moreover also desirable to achieve a reduction in production costs.

### SUMMARY

The teachings of the present disclosure describe improved methods and a correspondingly improved lithium-ion cell. For example, some embodiments include a method for producing a galvanic lithium-ion cell, wherein a separator (12) is provided in order to spatially separate a first electrode material (14) of the lithium-ion cell from a second electrode material (16), characterized in that the first electrode material (14) is applied to a first side (18) of the separator (12) by coating.

In some embodiments, the second electrode material (16) is applied to a second side (20), which lies opposite the first side (18), of the separator (12) by coating.

In some embodiments, a solid-state electrolyte is used as the separator (12), which is in particular formed by a membrane.

In some embodiments, a multiplicity of folding points (26) is formed in a separator arrangement (10) that comprises the separator (12) and the at least one electrode material (14, 16) applied by coating, and the separator arrangement (10) is folded in mutually opposing directions at consecutive folding points (26).

In some embodiments, at least one of the folding points (26) is formed by at least partly removing the at least one electrode material (14, 16) from the separator (12) at the folding point (26) and/or by applying, at least one of the folding points (26), the at least one electrode material (14, 16) to the separator (12) with a layer thickness that is reduced in comparison with regions adjoining the folding point (26), in particular reduced to 0.

In some embodiments, a thickness of the separator (12) is reduced at the at least one folding point (26).

In some embodiments, at least one collector layer (22, 24) is applied to a separator arrangement (10) that comprises the separator (12) and the at least one electrode material (14, 16) applied by coating, in particular by physical vapor deposition and/or by way of a rotating cylinder.

In some embodiments, an electrically conductive connection is produced between the collector layer (22, 24) and an electrical conductor (30, 32), in particular between the collector layer (22, 24) and a metal conductor embedded in an electrically conductive adhesive.

In some embodiments, the electrically conductive connection is produced at the folding points (26) between the collector layer (22, 24) and the electrical conductor (30, 32).

In some embodiments, the at least one electrode material (14, 16) is applied to the separator (12) by way of at least one rotating cylinder.

As another example, some embodiments include a galvanic lithium-ion cell, produced by way of a method as described above, wherein the lithium-ion cell is designed as a solid-state cell.

### BRIEF DESCRIPTION OF THE DRAWINGS

An example embodiment of the teachings herein is described below. To that end, in the figures:

FIG. 1 shows, highly schematically, a membrane coated on both sides with electrode material of a lithium-ion cell; and

FIG. 2 shows a schematic side view of the membrane folded at a multiplicity of folding points, wherein contact is made at the folding points with collector layers applied to the respective electrode materials by way of an electrical conductor.

### DETAILED DESCRIPTION

Various embodiments include methods for producing a galvanic lithium-ion cell, wherein a separator is initially provided. The separator serves to spatially separate a first electrode material of the lithium-ion cell from a second electrode material of the lithium-ion cell. The separator furthermore prevents electrons from passing from the first electrode material to the second electrode material through the separator. In the method, the first electrode material is applied to a first side of the separator by coating. In other words, the separator, which is initially provided in uncoated form and which separates the two electrode materials from one another in the subsequent cell, thus serves as a coating carrier. It is thus possible firstly to ensure a particularly even and thorough distribution of the electrode material on the first side of the separator. Furthermore, the electrode material thus protects the separator during further processing in the context of the production of the lithium-ion cell. This makes the production method particularly robust and reliable in terms of process. An improved method is accordingly provided.

In some embodiments, the coating may be performed for example by applying a flowable or pasty starting material to the side of the separator and then reducing the liquid content of this starting material, in particular by drying in a furnace, in order to provide the electrode material. A layer, which is comparatively thin and thus saves starting material, of the electrode material is thus also able to be applied to the side of the separator particularly evenly and extensively.

In some embodiments, the second electrode material is likewise applied to a second side, which lies opposite the first side, of the separator by coating. In this way, specifically, it is also possible to provide protection for the separator on the second side of said separator, and it is possible to achieve a particularly even distribution of the electrode material on the second side of the separator as well. Use may be made of a separator that allows the lithium ions to migrate, by way of a fluid electrolyte, from the first electrode material into the second electrode material and back during charging, respectively discharging, of the galvanic cell.

With regard to the handling of the separator during production and with regard to material costs, a solid-state electrolyte may be used as the separator. Although such a solid ion conductor is permeable to the lithium ions, it prevents the electrons from passing through the separator. The solid-state electrolyte may be in particular a membrane that is designed as an ion-conductive polymer. Such a self-supporting membrane is specifically able to be coated on at least one side, but in some cases on both sides, with the electrode material particularly easily and reliably in terms of process.

In some embodiments, a multiplicity of folding points is formed in a separator arrangement that comprises the separator and the at least one electrode material applied by coating. In this case, the separator arrangement is folded in mutually opposing directions at consecutive, in particular linear, folding points. A particularly large surface of the electrode material is provided in a given volume of the lithium-ion cell through such a Z-fold. In addition, it is thus able to be ensured that the individual layers of the separator arrangement are positioned very precisely in relation to one another on account of the separator passing through the multiplicity of folding points. This is because the separator holds the individual layers of the Z-fold together.

If by contrast a separator is in each case arranged between individual collector foils on which the electrode material is arranged, in the case of such an unfolded stack, it is thus possible to achieve a situation whereby the individual layers come to lie as accurately as possible on one another only with great difficulty. By virtue of the Z-folding, that is to say the folding in the mutually opposing directions at the consecutive folding points, further processing of the separator arrangement is thus considerably simplified.

To enable the Z-folding of the separator arrangement or of the cell structure, at least one of the folding points may be formed by at least partly removing the at least one electrode material from the separator at the folding point. It is then specifically possible to perform bending of the separator arrangement at the folding point particularly easily. The electrode material may in this case be removed both in a region external to the curve of the curve-shaped folding point or fold and in a region internal to the curve of the folding point. By way of example, a trench or a recess may be formed in the at least one electrode material, for instance by way of a laser, the separator in particular being able to be exposed in the region of this trench. The separator arrangement is then able to be turned or folded particularly easily at this point.

In some embodiments, the at least one electrode material, at least one of the folding points, may be applied to the separator with a layer thickness that is reduced in comparison with regions adjoining the folding point. Such a structuring also makes it possible to achieve a situation whereby the separator arrangement is able to be folded more easily at the folding point. In this design of the folding point, the reduced layer thickness may likewise be present both in the region external to the curve of the folding point and in the region internal to the curve of the folding point.

The layer thickness of the electrode material at the folding point may in particular be reduced to 0. Accordingly, when coating the at least one side of the separator, that region of the separator arrangement that serves as folding point during further processing may remain uncoated in order to facilitate subsequent folding of the separator arrangement. This may be achieved by sequential or regional coating of the first side or of the first side and the second side of the separator.

A corresponding structuring of the separator arrangement at the folding points makes it possible to ensure that no excessively high mechanical stresses arise during folding at the respective folding point. To achieve this, a thickness of the separator may additionally be reduced at the at least one folding point. However, it is in this case ensured that the separator is nevertheless still present at the folding point, such that the electrically insulating effect of the separator in relation to the electrons is maintained.

A collector layer may be applied to a separator arrangement that comprises the separator and the at least one electrode material applied by coating. It is then not necessary to handle separate collector foils during the production of the lithium-ion cell, but rather the collector layer becomes an integral component of the separator arrangement. Extensive contact between the collector layer and the electrode material is additionally able to be ensured particularly well. This is expedient for good collection of the electric current during charging or discharging of the lithium-ion cell. Furthermore, handling of the separator arrangement during the production of the lithium-ion cell is simplified if the collector layer is connected to the separator via the electrode material. This is the case for example when the separator arrangement, which comprises the collector layer, is intended to be folded at the folding points.

In some embodiments, a respective collector layer may be applied to the two electrode materials applied to the separator by coating. To apply the collector layer to the at least one electrode material, use may be made in particular of a rotating cylinder on whose surface facing the electrode material the starting material for the collector layer is arranged. In particular in the case of using copper for the collector layer facing the electrode material, for instance in the form of graphite with embedded lithium ions, physical vapor deposition has furthermore proven to be an advantageous method for applying the collector layer. By way of example, the collector layer may thus be applied to the electrode material by sputtering, in particular high-rate sputtering (high-speed sputtering). This applies analogously when aluminum is applied to the electrode material by way of physical vapor deposition, that is to say for example by sputtering or high-rate sputtering, as collector layer facing a lithium metal oxide as electrode material.

In some embodiments, using high-rate sputtering (high-speed sputtering), a collector layer having a particular thickness may be produced within a shorter time than is the case with sputtering at normal speed. In some embodiments, the collector layers are thus able to be provided particularly quickly. In addition, when providing the collector layer, it is not necessary to provide any particularly stringent requirements in terms of the evenness of the layer thickness. By way of example, high-rate sputtering is therefore also particularly well-suited to forming the collector layers.

An electrically conductive connection may be produced between the collector layer and an electrical conductor. A flow of current via the electrical conductor to an electrical terminal of the lithium-ion cell is then able to be achieved particularly easily. The electrically conductive connection may in particular be produced between the collector layer and a metal conductor that is embedded in an electrically conductive adhesive. The metal conductor is thus securely attached to the collector layer, and a flow of current is able to be achieved with a particularly low contact resistance. The metal conductor may be designed in particular as a wire with a substantially round cross section or as a substantially strip-shaped, flat conductor.

In some embodiments, the electrically conductive connection between the collector layer and the electrical conductor is produced at the folding points. The electrical conductor may accordingly make contact with the collector layer at the folding points and thus ensure particularly good collection of the electrons from the electrode material arranged between respective folding points during charging or discharging of the lithium-ion cell. In particular, when the electrically conductive connection between the collector layer and the electrical conductor at the folding points is provided by adhesively bonding the metal conductor by way of the electrically conductive adhesive, good attachment of the separator arrangement in the folded state is at the same time able to be ensured.

In some embodiments, the at least one electrode material may also be applied to the separator by physical vapor deposition, in particular by sputtering. However, the coating process is able to be performed particularly easily in a virtually endless or continuous method when the at least one electrode material is applied to the separator by way of at least one rotating cylinder. In this case, the separator may also be guided via a roll or a cylinder, such that coating is able to be achieved in a roll-to-roll method.

To provide a lithium-ion cell with a desired electrical capacity, it is then merely necessary to cut through the separator, which is in particular coated on both sides with the respective electrode material. A corresponding separator arrangement having the desired length may then be inserted into a housing of the lithium-ion cell. If the lithium-ion cell is designed as what is known as a pouch cell or a coffee-bag cell, then the housing is formed from a flexible, foil-type material. In the case of a design as a lithium-ion cell having a rigid, inherently stiff housing, an arrangement in a prism-shaped housing or cell housing may in particular be provided. In particular, the folded separator arrangement is specifically able to be accommodated particularly well in such a cell housing of a prism-shaped cell or in a cell housing of a pouch cell, such that good contact is able to be made with the electrical terminals or the electrical poles of the lithium-ion cell.

As described below, the components each constitute individual features which should be considered independently of one another and should thus also be regarded as part of the teachings individually or in a different combination than that shown. Furthermore, the embodiment described is also able to be supplemented by further features of the teachings from among those that have already been described. In the figures, functionally identical elements are provided in each case with the same reference signs.

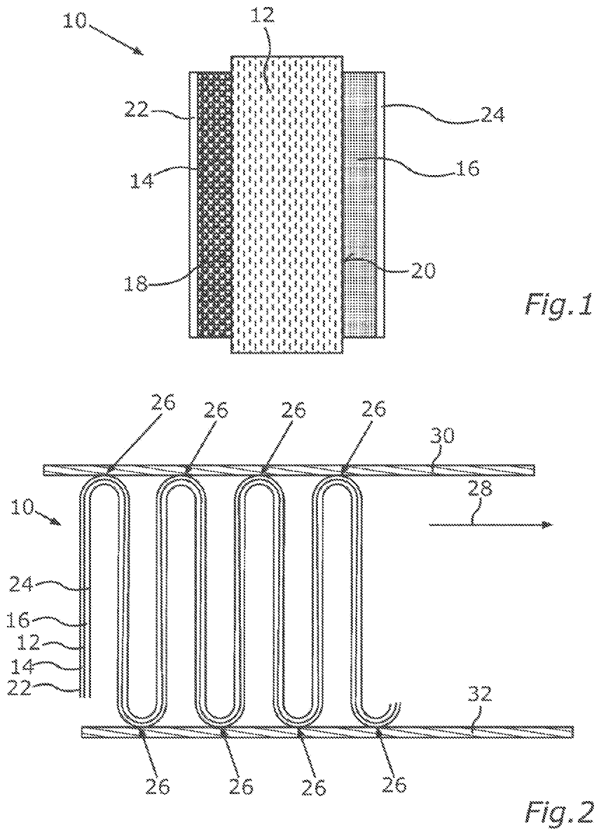

FIG. 1 sectionally and schematically shows a structure of a separator arrangement 10 for a galvanic lithium-ion cell incorporating teachings of the present disclosure. A separator 12 is in this case provided by a membrane. The separator 12 serves to spatially separate a first electrode material 14, which may be for example the negative electrode of the lithium-ion cell, from a second electrode material 16, which may be for example the positive electrode of the lithium-ion cell. In the present case, both electrode materials 14, 16 are applied to the separator 12 by coating. The membrane serving as separator 12 is thus coated with the respective electrode material 14, 16 on both sides.

By way of example, the first electrode material 14 is applied to a first side 18 of the separator 12 by coating. Accordingly, the second electrode material 16 is applied to a second side 20 of the separator 12 by coating in the refinement shown in FIG. 1. The second side 20 lies opposite the first side 18 of the separator 12. The first electrode material 14 may in particular be graphite or the like in which lithium ions are embedded. By contrast, the second electrode material 16 may for instance be a lithium metal oxide.

In the present case, however, these electrochemically active materials in the form of the first electrode material 14 and of the second electrode material 16 are not applied as is otherwise conventional to collector foils between which the separator 12 is then arranged. The separator 12 is rather coated with the first electrode material 14 on the first side 18 and with the second electrode material 16 on the opposite side 20. The thus-formed separator arrangement 10 is then processed further.

The separator 12 may in particular be designed as a solid-state electrolyte. The galvanic lithium-ion cell that has the separator arrangement 10 is then a solid-state cell or a solid-state accumulator in which both the electrodes and the electrolyte consist of solid material. The separator 12 spatially separates the electrode materials 14, 16 and ensures that ions, that is to say in the present case the lithium ions, are able to pass through the separator 12. By contrast, the separator 12 is not conductive for electrons. During charging or discharging of the lithium-ion cell, the current accordingly flows from the first electrode material 14 to the second electrode material 16 or from the second electrode material 16 to the first electrode material 14, respectively, through a corresponding external circuit (not shown here).

In the context of the further processing of the separator arrangement 10 in order to produce the lithium-ion cell, a respective collector layer 22, 24 is preferably applied to the respective electrode material 14, 16. By way of example, for the negative electrode, which may be formed by the first electrode material 14, a layer made from copper may be applied as collector layer 22. By contrast, a layer made from aluminum may be applied as the collector layer 24 to the positive electrode, which is formed by the second electrode material 16.

The thus-formed separator arrangement 10, which also comprises the two collector layers 22, 24, is then folded (cf. FIG. 2). To this end, a plurality folding points 26 each in a straight line are formed in the separator arrangement 10. The separator arrangement 10 is folded in mutually opposing directions at the folding points 26 that are consecutive in a stacking direction 28. The stacking direction 28 is illustrated by an arrow in FIG. 2.

To facilitate such Z-folding of the separator arrangement 10 by bending or turning the separator arrangement 10 at the respective folding point 26, a corresponding structure may be provided at the respective folding point 26. By way of example, a trench or a depression of this type may be produced in the respective electrode material 14, 16, for example by way of a laser. The thickness of the respective electrode or of the electrode material 14, 16 is then reduced at this point.

The electrode material 14, 16 may in particular be completely removed from the separator 12 here, that is to say at the respective folding point 26. The structure, for instance the trench, may also extend into the separator 12. Such structures, which facilitate further processing of the separator arrangement 10 through the Z-folding illustrated in FIG. 2, are preferably formed before the respective collector layer 22, 24 is applied to the electrode material 14, 16. The corresponding structures at the folding points 26 make it possible to ensure that no excessively high mechanical stresses arise during Z-folding at the folding points 26.

In some embodiments, contact is made with the collector layer 22, which is arranged on the first electrode material 14, by way of a first electrical conductor 30. A metal conductor, for instance in the form of a wire, which is embedded in a conductive adhesive, may be used for example as this first electrical conductor 30. This flexible conductive adhesive makes contact with the stacked or folded separator arrangement 10 at the folding points 26. Further contact is thus ensured by the first electrical conductor 30. The electrons, for instance during discharging of the lithium-ion cell, are routed to an electrical terminal or electrical pole of the battery cell (not shown here) or lithium-ion cell via the conductor 30. During charging, the electrons are accordingly fed via the conductor 30.

In some embodiments, a second electrical conductor 32 makes contact with the collector layer 24, which is applied to the second electrode material 16, at further linear folding points 26 of the separator arrangement 10. The further folding points 26 lie opposite those folding points 26 at which the first electrical conductor 30 makes contact with the collector layer 22. The second electrical conductor 32 may also be formed as a conductive adhesive and accordingly comprise a metal conductor that is embedded in an electrically conductive adhesive. The second electrical conductor 32 accordingly ensures that the electrons are collected at the other electrical pole (respectively) of the lithium-ion cell or battery cell during charging or that the electrons are fed from the pole during discharging, respectively.

In some embodiments, the electrode materials 14, 16, but in particular the collector layers 22, 24, may be applied for example by high-rate sputtering (high-speed sputtering). It is thus possible to provide thin collector layers 22, 24 that extensively cover the respective electrode material 14, 16 or at least the separator 12 at the folding points 26 particularly easily.

In some embodiments, the electrode materials 14, 16 may be applied to the separator 12 by way of a rotating cylinder, that is to say in a roll-to-roll method. After coating a particular length, able to be measured in the stacking direction 28, of the separator arrangement 10, the separator 12 coated with the electrode materials 14, 16 then only needs to be cut through (in particular after the collector layers 22, 24 have been applied to the electrode materials 14, 16) in order to provide a corresponding lithium-ion cell having a particular or desired electrical capacity. Overall, the example shows a galvanic cell having a coated membrane.

### LIST OF REFEENCE SIGNS

10 Separator arrangement

12 Separator

14 Electrode material

16 Electrode material

18 Side

20 Side

22 Collector layer

24 Collector layer

26 Folding point

28 Stacking direction

30 Electrical conductor

32 Electrical conductor

What is claimed is:

1. A method for producing a galvanic lithium-ion cell, the method comprising:
separating a first electrode material from a second electrode material using a separator; and
applying the first electrode material to a first side of the separator by coating.

2. The method as claimed in claim 1, further comprising applying the second electrode material to a second side opposite the first side of the separator by coating.

3. The method as claimed in claim 1, wherein the separator comprises a solid-state electrolyte membrane.

4. The method as claimed in claim 1, further comprising forming a multiplicity of folding points in the separator;
wherein the first electrode material and the separator arrangement are folded in mutually opposing directions at consecutive folding points.

5. The method as claimed in claim 4, further comprising forming at least one of the multiplicity of folding points by at least partly removing the electrode material from the separator at the folding point.

6. The method as claimed in claim 4, further comprising reducing a thickness of the separator at the at least one folding point.

7. The method as claimed in claim 1, further comprising applying a collector layer to the separator; and
wherein applying the electrode material comprising physical vapor deposition or using a rotating cylinder.

8. The method as claimed in claim 7, further comprising producing an electrically conductive connection between the collector layer and an electrical conductor.

9. The method as claimed in claim 8, wherein the electrically conductive connection is produced at folding points between the collector layer and the electrical conductor.

10. The method as claimed in claim 1, wherein the electrode material is applied to the separator by way of at least one rotating cylinder.

11. (canceled)

12. The method as claimed in claim 4, further comprising forming at least one of the multiplicity of folding points by applying, at one of the folding points, the electrode material to the separator with a layer thickness that is reduced in comparison with regions adjoining the folding point.
